(19) United States
(12) Patent Application Publication
(10) Pub. No.: US 2016/0142729 A1
(43) Pub. Date: May 19, 2016

(54) CODING METHOD BASED ON MULTI-HYPOTHESIS MOTION COMPENSATION FOR P-FRAME

(71) Applicant: PEKING UNIVERSITY SHENZHEN GRADUATE SCHOOL, Shenzhen (CN)

(72) Inventors: Ronggang WANG, Shenzhen (CN); Lei CHEN, Shenzhen (CN); Zhenyu WANG, Shenzhen (CN); Siwei MA, Shenzhen (CN); Wen GAO, Shenzhen (CN); Tiejun HUANG, Shenzhen (CN); Wenmin WANG, Shenzhen (CN); Shengfu DONG, Shenzhen (CN)

(21) Appl. No.: 15/006,144

(22) Filed: Jan. 26, 2016

Related U.S. Application Data
(63) Continuation-in-part of application No. PCT/CN2013/080179, filed on Jul. 26, 2013.

(51) Int. Cl. H04N 19/52; H04N 19/43; H04N 19/176

(52) U.S. Cl. CPC H04N 19/52; H04N 19/176; H04N 19/43

(57) ABSTRACT

A coding method based on multi-hypothesis motion compensation for a P-frame, including: a) using neighboring coded image blocks as reference image blocks, adopting a motion vector of each reference image block as a first motion vector which points to a first prediction block; b) adopting the first prediction block corresponding to each reference image block as a reference value, and performing joint motion estimation on the current image block to acquire a second motion vector which points to a second prediction block; c) weighted averaging the first prediction block and the second prediction corresponding to each reference image block to acquire a third prediction block of the current image block, respectively; and d) calculating a coding cost corresponding to each reference image block to determine a final first motion vector, a final second motion vector, and a final prediction block of the current image block.

### CROSS-REFERENCE TO RELATED APPLICATIONS

This application is a continuation-in-part of International Patent Application No. PCT/CN2013/080179 with an international filing date of Jul. 26, 2013, designating the United States, now pending. The contents of all of the aforementioned applications, including any intervening amendments thereto, are incorporated herein by reference. Inquiries from the public to applicants or assignees concerning this document or the related applications should be directed to: Matthias Scholl P.C., Attn.: Dr. Matthias Scholl Esq., 245 First Street, 18th Floor, Cambridge, Mass. 02142.

### BACKGROUND OF THE INVENTION

1. Field of the Invention

The invention relates to the technical field of video coding, and more particularly to a coding method based on multi-hypothesis motion compensation for a P-frame.

2. Description of the Related Art

Typical motion compensation for P-frame has inaccurate prediction blocks. The bidirectional motion compensation for B-frame produces a forward motion vector and a backward motion vector. The two motion vectors are transmitted in the bit stream, which undesirably increases the bit rate.

### SUMMARY OF THE INVENTION

In view of the above described problems, it is one objective of the invention to provide a coding method based on multi-hypothesis motion compensation for a P-frame that is adapted to improve the accuracy of the prediction block of the motion compensation for the P-frame without increasing the bit rate.

To achieve the above objective, in accordance with one embodiment of the invention, there is provided a coding method based on multi-hypothesis motion compensation for a P-frame. The method comprises:
a) using neighboring coded image blocks of a current image block as reference image blocks, adopting a motion vector of each reference image block as a first motion vector of the current image block respectively, in which, the first motion vector points to a first prediction block;
b) adopting the first prediction block corresponding to each reference image block as a reference value, and performing joint motion estimation on the current image block to acquire a second motion vector of the current image block corresponding to each reference block, in which, the second motion vector points to a second prediction block;
c) weighted averaging the first prediction block and the second prediction corresponding to each reference image block to acquire a third prediction block of the current image block, respectively; and
d) calculating a coding cost when using the first motion vector and the second motion vector corresponding to each reference image block for coding, and selecting the first motion vector, the second motion vector, and the third prediction block that have an minimum coding cost as a final first motion vector, a final second motion vector, and a final prediction block of the current image block.

In a class of this embodiment, the reference image blocks are two image blocks selected from the neighboring coded image blocks of the current image block.

In a class of this embodiment, in weighted averaging the first prediction block and the second prediction block corresponding to each reference image block for obtaining the third prediction block of the current image block, a sum of weights of the first prediction block and the second prediction block is 1.

In a class of this embodiment, the weights of the first prediction block and the second prediction block are ½ respectively.

In a class of this embodiment, the method further comprises: e) adding a residual information between the current image block and the final prediction block, an identification information of the final first motion vector, and the final second motion vector to a coded bit stream of the current image block. The identification information of the first motion vector points to the reference image block corresponding to the first motion vector having the minimum coding cost.

Advantages of the coding method based on the multi-hypothesis motion compensation for the P-frame of the invention according to embodiments of the invention are summarized as follows: the neighboring coded image blocks of the current image block are utilized as the reference image blocks to obtain the first motion vector corresponding to each reference image block, the joint motion estimation is performed by referring to the separate first motion vector to obtain the corresponding second motion vector, and the first motion vector, the second motion vector, and the third prediction block that have the minimum coding cost are selected as the final first motion vector, the final second motion vector, and the final prediction block of the current image block, so that the final prediction block of the current image block has much higher accuracy, and the bit rate of the bit stream transmission is not increased.

### BRIEF DESCRIPTION OF THE DRAWINGS

The invention is described hereinbelow with reference to the accompanying drawings, in which:

FIG. 1 is a structure diagram of reference image blocks according to one embodiment of the invention;

FIG. 2 is a structure diagram of reference image blocks according to another embodiment of the invention;

FIG. 3 is a block diagram of a coding method in a current typical video coding standard;

FIG. 4 is a flow chart illustrating a coding method based on multi-hypothesis motion compensation for a P-frame in accordance with one embodiment of the invention;

FIG. 5 is a structure diagram showing acquisition of prediction blocks of a current image block in accordance with one embodiment of the invention; and

FIG. 6 is a block diagram of a decoding method corresponding to a coding method based on a multi-hypothesis motion compensation for a P-frame in accordance with one embodiment of the invention.

### DETAILED DESCRIPTION OF THE EMBODIMENTS

For further illustrating the invention, experiments detailing a coding method based on multi-hypothesis motion compensation for a P-frame are described below. It should be noted that the following examples are intended to describe and not to limit the invention

The coding method based on the multi-hypothesis motion compensation for the P-frame provided in the invention is applicable for the technical field of the video coding. The conception of the invention is based on weighing the advantages and shortages of the motion compensations for the B-frame and the P-frame to provide the coding method based on multi-hypothesis motion compensation for the P-frame that utilizes the temporal correlation as well as the spatial correlation to achieve much higher accuracy of the prediction block and that only requires transmission of one motion vector into the bit stream thus not increasing the bit rate of the bit stream.

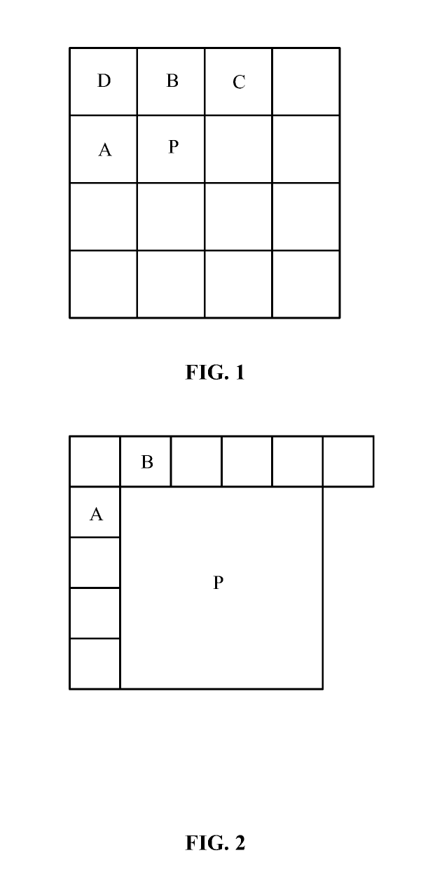

In video coding, each image frame is divided into macro blocks with fixed size, and image blocks in each image frame are processed from a first at the upper left according to an order from left to right and from top down. As illustrated in FIG. 1, the image frame is divided into macro blocks (image blocks) with each image block having a size of 16*16 pixels. The image frame is processed as follows: a first row of the image blocks are first processed from left to right, then a second row of the image blocks are processed, and remaining image blocks are processed likewise until the treatment of the whole image frame is accomplished.

Assuming that an image block P is a current image block, in some embodiments of the invention, when performing motion compensation of the current image block P, motion vectors of the reference image blocks are utilized as reference values to calculate first motion vectors of the current image block, respectively. Because each image block in the image frame possesses the highest similarity with the neighboring coded image blocks. Thus, the neighboring coded image blocks of the current image block are adopted as the reference image blocks. As shown in FIG. 1, the reference image blocks of the current image block P are A, B, C, and D.

In some embodiments of the invention, in selection of the reference image blocks, neighboring image blocks at the upper, the upper right, or the right of the current image block are optionally selected as the reference image blocks, for example, the reference image blocks A, B, and C of the current image block P in FIG. 1 are selected. In condition that the upper right image block of the current image block does not exist (when the current image block is at the right of the first row) or that the image block C does not possess the motion vector, the upper left image block of the current image block is utilized for substituting the upper right image block, for example, A, B, and D are selected as the reference image blocks of the current image block P in FIG. 1.

In some embodiments of the invention, the image block is further divided into sub-image blocks when coding the image block, for example, the image block having the size of 16*16 pixels are further divided into sub-image blocks having the size of 4*4 pixels, as shown in FIG. 2.

In some embodiments of the invention, in acquiring the first motion vectors of the current image blocks, the neighboring coded sub-image blocks of the current image block adopted as the reference image blocks are illustrated as an example. For better understanding the invention, the neighboring coded sub-image blocks of the current image block are generally called the neighboring coded image blocks of the current image block.

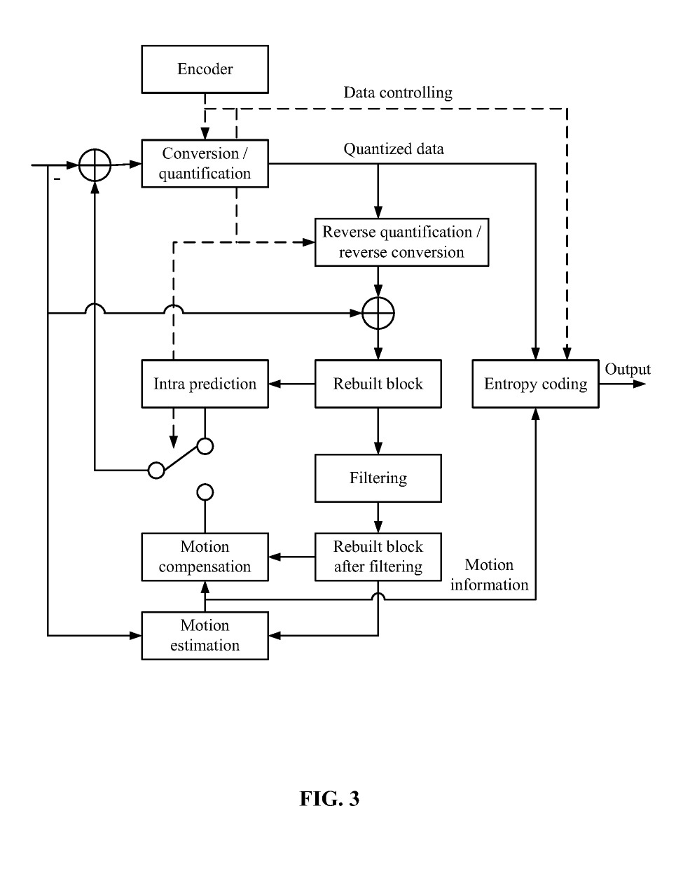

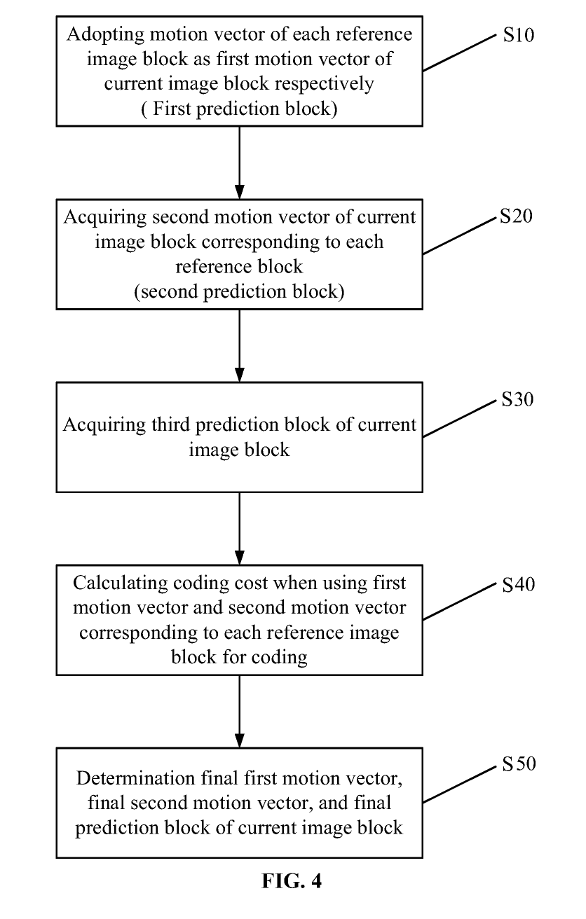

A coding block diagram in the current typical video coding standard is shown in FIG. 3, in which, the input image frame is divided into a plurality of macro blocks (image blocks), and the current image block is performed with intra-prediction (intra coding) or motion compensation (inter coding), and the coding mode that has the minimum coding cost is selected by a mode decision process to obtain the prediction block of the current image block. A difference between the current image block and the prediction block is calculated to obtain a residual value which is then, converted, quantified, scanned, and entropy coded so as to output of a bit stream sequence.

In the invention, improvements are made in the motion estimation and the motion compensation. In the motion estimation, the neighboring coded image blocks of the current image block are utilized as the reference image blocks, motion vectors of the reference image blocks are adopted as first motion vectors of the current image block respectively, then the first motion vectors corresponding to the reference image blocks are utilized as reference values respectively, and the current image block is performed with joint motion estimation to acquire second motion vectors of the current image block corresponding to the reference image blocks. In the motion compensation for acquiring third prediction blocks, the third prediction blocks are acquired by weighed averaging first prediction blocks pointed by corresponding first motion vectors and second prediction blocks pointed by the corresponding second motion vectors, respectively. Thereafter, the coding costs when using the first motion vectors and the second motion vectors corresponding to the reference image blocks for coding are calculated respectively, and the first motion vector, the second motion vector, and the third prediction block that have the minimum coding cost are selected as a final first motion vector MVL1, a final second motion vector MVL2, and a final prediction block PL of the current image block. In some embodiments of the invention, it only requires to transmit an identification information of the final first motion vector MVL1, one motion vector (MVL2), and a residual information between the current image block and the final prediction block for performing the entropy coding, thus the bit rate of the bit stream transmission is not increased.

As illustrated in FIG. 4, a coding method based on multi-hypothesis motion compensation for a P-frame comprises:

S10: using the neighboring coded image blocks of the current image block as the reference image blocks, adopting the motion vector of each reference image block as the first motion vector of the current image block respectively, in which the first motion vector points to a first prediction block;

S20: adopting the first prediction block corresponding to each reference image block as the reference value, and performing joint motion estimation on the current image block to acquire the second motion vector of the current image block corresponding to each reference block, in which the second motion vector points to a second prediction block;

S30: weighted averaging the first prediction block and the second prediction corresponding to each reference image block to acquire the third prediction block of the current image block, respectively; and

S40: calculating the coding cost when using the first motion vector and the second motion vector corresponding to each reference image block for coding, and selecting the first motion vector, the second motion vector, and the third prediction block that have the minimum coding cost as the final first motion vector, the final second motion vector, and the final prediction block of the current image block.

In one embodiment of the invention, in S10, the reference image blocks are two image blocks A, B selected from the neighboring coded image blocks of the current image block. In other embodiments, other neighboring coded image blocks of the current image block are optionally selected as the reference image blocks, or all the neighboring coded image blocks of the current image block are selected as the reference image blocks.

When the image blocks A, B in FIG. 2 are selected as the reference image blocks, then the first motion vector in S10 have two choices, that is, the motion vector is equal to a motion vector value of the reference image block A or equal to a motion vector value of the reference image block B.

In S20, for the two choices of the first motion vector, the first motion vector is adopted as the reference value respectively, and the current image block is performed with the joint motion estimation to acquire the corresponding second motion vector of the current image block.

The second motion vector MVL2 is derived by the joint motion estimation using the first motion vector MVL1 as the reference value, and an equation of the second motion vector MVL2 is as follows:

MVL2=f(MVL1) (1)

in which, f represents a function of joint motion estimation related to the first motion vector MVL1.

The estimation process of the second motion vector using the joint motion estimation is the same as the common motion estimation process (such as the common motion estimation process of the B-frame), thus not being illustrated herein. Because the first motion vector MVL1 is referred in the derivation of the second motion vector MVL2 by the joint motion estimation, in calculation of the Lagrangian function, a minimum motion vector of the Lagrangian cost function (Equation 2) within a searching range is adopted as the second motion vector MVL2.

J(λsad,MVL2)=Dsad(S,MVL2,MVL1)+λsad*R(MVL2−MVL2pred) (2)

in which, MVL2pred is a prediction value of MVL2, R(MVL2−MVL2pred) represents a number of bits to code a motion vector residue (the difference between MVL2 and MVL2pred), λsad represents a weighted coefficient of R(MVL2−MVL2pred), and Dsad(S, MVL2, MVL1) represents a difference between the current image block S and a prediction block and is acquired by Equation 3.

Dsad(S,MVL2,MVL1)=Σ_{(x,y)}|S(x,y)−(Sref(x+MVL2x,y+MVL2y)+Sref(x+MVL1x,y+MVL1y)>>1)| (3)

in which, x, y represent relative coordination positions of pixels in the current image block S within the current coding frame, MVL1x, MVL1y, MVL2x, and MVL2y represent horizontal and vertical components of MVL1 and MVL2 respectively, and Sref represents a reference frame.

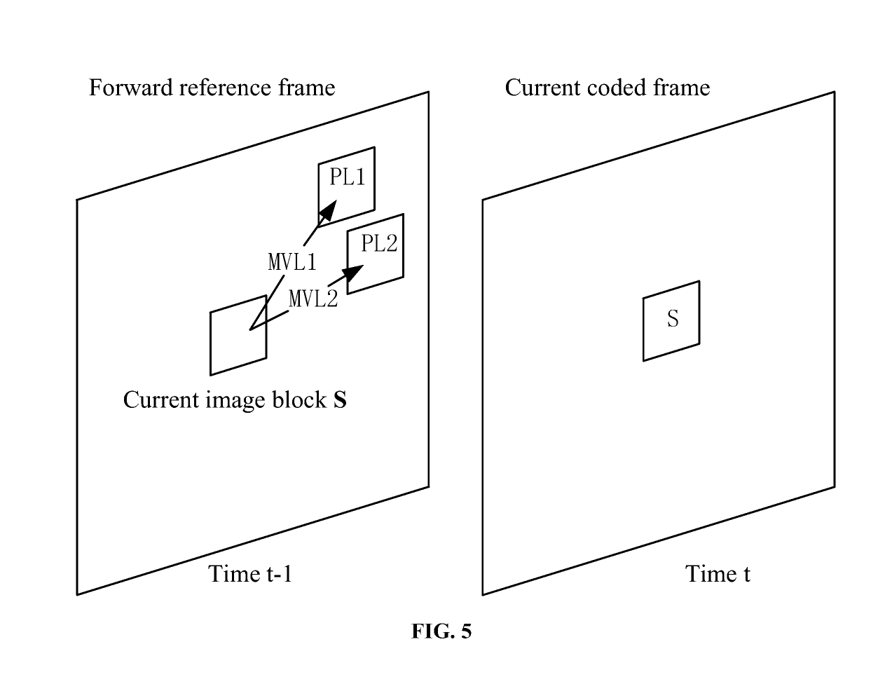

The acquisition of the prediction blocks of the current image block is illustrated in FIG. 5, in which, the image frame at a time of t−1 functions as a forward reference frame, and the image frame at a time oft is the current coded frame. In S30, the first image block PL1 and the second image block PL2 are weighed averaged to acquire the third prediction block PL of the current image block S, that is PL=aPL1+bPL2, in which, a and b represent weight coefficients, and a+b=1. In one embodiment of the invention, a=b=½, that is, weights of the first prediction block PL1 and the second prediction block PL2 are both ½.

Because in every choice, the first motion vector and the second motion vector correspond to the same coding cost, the coding costs of the two choices are calculated in S40.

In S50, the first motion vector, the second motion vector, and the third prediction block that have the minimum coding cost are selected as the final first motion vector, the final second motion vector, and the final prediction block of the current image block, that is, in condition that the coding cost when adopting the motion vector of the reference image block A as the first motion vector is smaller than the coding cost when adopting the motion vector of the reference image block B as the first motion vector, the first motion vector, the second motion vector, and the third prediction block corresponding to the reference image block A are selected as the final first motion vector, the final second motion vector, and the final prediction block of the current image block; otherwise, the first motion vector, the second motion vector, and the third prediction block corresponding to the reference image block B are selected as the final first motion vector, the final second motion vector, and the final prediction block of the current image block.

In one embodiment of the invention, after selecting the first motion vector, the second motion vector, and the third prediction block that have the minimum coding cost as the final first motion vector, the final second motion vector, and the final prediction block of the current image block, a residual information between the current image block and the final prediction block, an identification information of the final first motion vector, and the final second motion vector are added to a coded bit stream of the current image block, in which the identification information of the final first motion vector points to the reference image block corresponding to the first motion vector having the minimum coding cost. For identifiers in the identification information of the final first motion vector, G denotes that the value of the final first motion vector equals to the motion vector value of the reference image block A, and 1 denotes that the value of the final first motion vector equals to the motion vector value of the reference image block B.

In one embodiment of the invention, the coded bit stream only includes one motion vector (the second motion vector) and the identification information of the final first motion vector, thus, the coding method based on the multi-hypothesis motion compensation for the P-frame of the invention is adapted to improve the accuracy of the P-frame prediction block without increasing the bit rate of the bit stream.

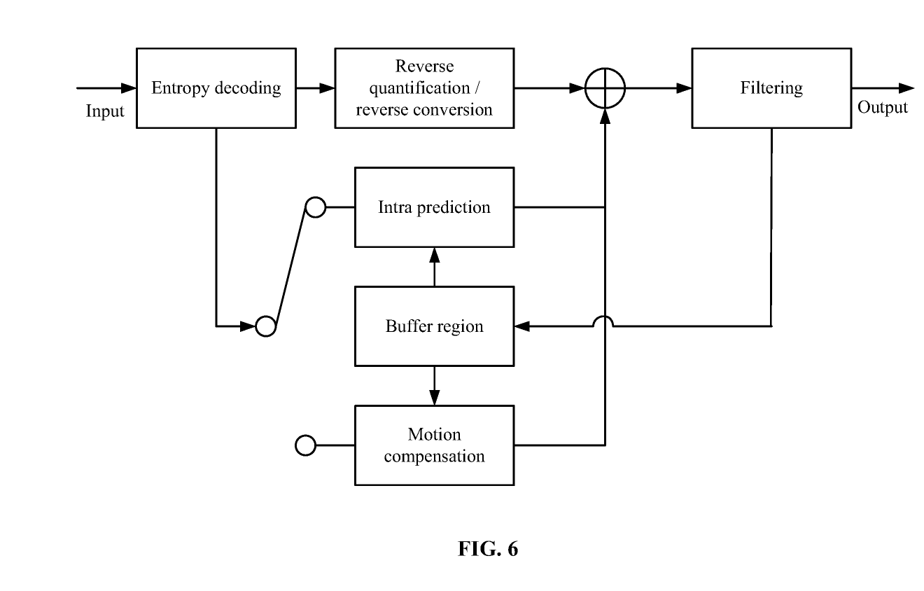

A block diagram of the decoding process is illustrated in FIG. 6. In the decoding terminal, when the bit stream is input, entropy decoding, reverse quantification, and reverse conversion are performed, and a selector is adopted to determine the intra-coding or the inter-coding. For the inter-coding, the prediction block of the current image block is acquire by the decoding information and a reconstruction frame of a reference buffer region, and the prediction block and the residual block are added to obtain the reconstruction block. For the method of the invention, the first motion vector is deduced by the identification information obtained by the entropy decoding, the specific deducing process can be referred to the derivation process of the first motion vector in the decoding terminal The value of the second motion vector is obtained by entropy decoding. The first motion vector and the second motion vector point to corresponding first prediction block and second prediction block in the reference reconstruction frame, and the final prediction block is acquired by weighted averaging the first prediction block and the second prediction block.

In the specific coding process, the coding method based on the multi-hypothesis motion compensation of the invention can be individually adopted to code the P-frame, or be utilized as a new coding mode to be added in the coding mode of the P-frame, and a coding mode that has the minimum coding cost is finally selected to perform the coding of the P-frame after the mode decision process.

It can be understood by the skills in the technical field that all or partial steps in the above method can be accomplished by controlling relative hardware by programs. These programs can be stored in readable storage media of a computer, and the storage media include: read-only memories, random access memories, magnetic disks, and optical disks.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

The invention claimed is:

1. A coding method based on multi-hypothesis motion compensation for a P-frame, the method comprising:
a) using neighboring coded image blocks of a current image block as reference image blocks, adopting a motion vector of each reference image block as a first motion vector of the current image block, the first motion vector pointing to a first prediction block;
b) adopting the first prediction block corresponding to each reference image block as a reference value, and performing joint motion estimation on the current image block to acquire a second motion vector of the current image block corresponding to each reference block, the second motion vector pointing to a second prediction block;
c) weighted averaging the first prediction block and the second prediction corresponding to each reference image block to acquire a third prediction block of the current image block, respectively; and
d) calculating a coding cost when using the first motion vector and the second motion vector corresponding to each reference image block to code, and selecting the first motion vector, the second motion vector, and the third prediction block that have an minimum coding cost as a final first motion vector, a final second motion vector, and a final prediction block of the current image block.

2. The method of claim 1, wherein the reference image blocks are two image blocks selected from the neighboring coded image blocks of the current image block.

3. The method of claim 1, wherein in c), a sum of weights of the first prediction block and the second prediction block is 1.

4. The method of claim 3, wherein the weights of the first prediction block and the second prediction block are ½, respectively.

5. The method of claim 1, further comprising:
e) adding a residual information between the current image block and the final prediction block, an identification information of the final first motion vector, and the final second motion vector to a coded bit stream of the current image block,
wherein
the identification information of the first motion vector points to the reference image block corresponding to the first motion vector having the minimum coding cost.

6. The method of claim 2, further comprising:
e) adding a residual information between the current image block and the final prediction block, an identification information of the final first motion vector, and the final second motion vector to a coded bit stream of the current image block,
wherein
the identification information of the first motion vector points to the reference image block corresponding to the first motion vector having the minimum coding cost.

7. The method of claim 3, further comprising:
e) adding a residual information between the current image block and the final prediction block, an identification information of the final first motion vector, and the final second motion vector to a coded bit stream of the current image block,
wherein
the identification information of the first motion vector points to the reference image block corresponding to the first motion vector having the minimum coding cost.

8. The method of claim 4, further comprising:
e) adding a residual information between the current image block and the final prediction block, an identification information of the final first motion vector, and the final second motion vector to a coded bit stream of the current image block,
wherein
the identification information of the first motion vector points to the reference image block corresponding to the first motion vector having the minimum coding cost.
